(19) United States
(12) Patent Application Publication
(10) Pub. No.: US 2017/0053338 A1
(43) Pub. Date: Feb. 23, 2017

(54) ENABLING TRANSACTIONAL ABILITY FOR OBJECTS REFERRED TO IN DIGITAL CONTENT

(71) Applicant: International Business Machines Corporation, Armonk, NY (US)

(72) Inventors: Mohan Narayanswamy, Bangalore (IN); Leho Nigul, Richmond Hill (CA); Niroop Setty, Bangalore (IN); Uttam Setty, Bangalore (IN)

(21) Appl. No.: 14/831,928

(22) Filed: Aug. 21, 2015

(51) Int. Cl. G06Q 30/06

(52) U.S. Cl. CPC G06Q 30/0633; G06Q 30/0631

(57) ABSTRACT

Embodiments of the present invention provide a method, computer program product, and computer system for enabling transactional capability for objects. The method includes sending a request for an object-vendor list applicable to digital content to a management engine. Responsive to receiving the object-vendor list from the management engine, the transactional capability for all unique objects in the object-vendor list is enabled. The display order of the object-vendor list is based on an assigned weight. The digital content is then sent to the user with enabled transactional capability.

### BACKGROUND OF THE INVENTION

The present invention relates generally to the field of e-commerce, and more particularly to enabling transactional capabilities for objects referred to in digital content and providing vendors of those objects.

Digital content is any type of content that exists in the form of digital data. Also known as digital media, digital content is stored on either digital or analog storage in specific formats. Forms of digital content include information that is digitally broadcast, streamed or contained in computer files. Viewed narrowly, types of digital content include popular media types, while a broader approach considers any type of digital information (e.g., digitally updated weather forecast, and GPS map) as digital content. Digital content has seen an increase as more households now have access to the Internet. Therefore it is easier for people to receive their news and watch television online, rather than from traditional platforms. Because of this increased access to the Internet, digital content is commonly published through individuals in the form of eBooks, blog posts, and even FACEBOOK® posts.

While browsing any digital content, a user may come across an object which the user wishes to purchase electronically, or an object of interest. If a user wishes to initiate an electronic purchase transaction of an item of interest, it can be done by visiting an e-commerce vendor's marketplace, website, or app to initiate a purchase transaction. Another method of initiating an electronic purchase is through a link, provided alongside the content where the object of interest is being referred to, that enables the user to initiate a transaction.

### SUMMARY

A method, computer program product, and computer system for enabling transactional ability for objects is provided, comprising: receiving, by one or more computer processors, a request for digital content; sending, by one or more computer processors, a request for an object-vendor list applicable to the digital content to a management engine; receiving, by one or more computer processors, an object-vendor list from the management engine; enabling, by one or more computer processors, transactional capability for all unique objects in the object-vendor list, wherein a display order of the object-vendor list is based on an assigned weight; and sending, by one or more computer processors, the digital content to a user, wherein the digital content comprises enabled transactional capability.

### BRIEF DESCRIPTION OF THE DRAWINGS

FIG. 1 is a functional block diagram illustrating an environment, in accordance with an embodiment of the present invention;

FIG. 2 is a flowchart depicting operational steps for enabling transactional capability, in accordance with an embodiment of the present invention;

FIG. 3 is a diagram depicting an example of transactional capability enabled digital content displayed on a computing device, in accordance with an embodiment of the present invention; and

FIG. 4 is a block diagram of internal and external components of a computer system, in accordance with an embodiment of the present invention.

### DETAILED DESCRIPTION

A user may not be able to determine the specifications of the item of interest to be able to clearly identify the object and may not know all of the e-commerce vendors that sell the item of interest. Moreover, even in cases where a user can successfully determine all of the required information about both the item of interest and vendors, it could take a considerable research effort. However, displaying a link within the digital content to add transactional ability consumes space available for original content's display. Moreover, if there are multiple items of interest and items of non-interest referred to in digital content, displaying links that add transactional ability to all items of interest may create a lot of clutter and fail to attract user attention to even one item. Embodiments of the present invention provide systems and methods to enable transactional capability to initiate an e-commerce transaction for items being referred to in any digital content, which would differ based on individual user information.

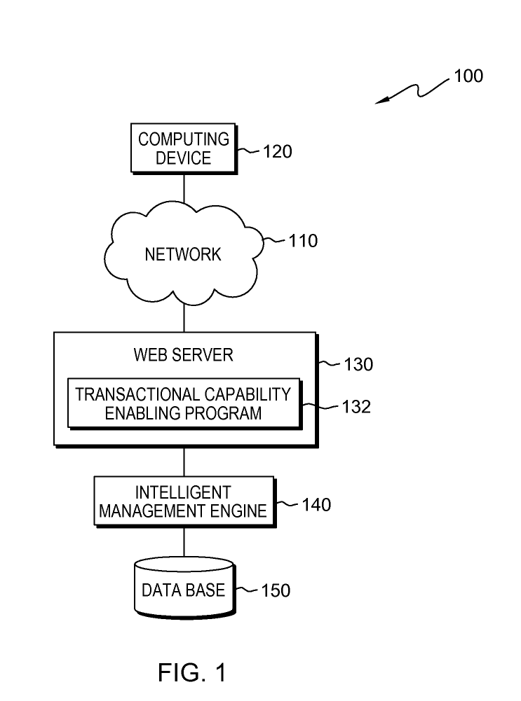

The present invention will now be described in detail with reference to the figures. FIG. 1 is a functional block diagram illustrating a transactional capability enabling environment, generally designated 100, in accordance with one embodiment of the present invention. FIG. 1 provides only an illustration of one implementation, and does not imply any limitations with regard to the environments in which different embodiments may be implemented. Many modifications to the depicted environment may be made by those skilled in the art without departing from the scope of the invention as recited by the claims. In an exemplary embodiment, transactional capability enabling environment 100 includes object and vendor database 150, intelligent management engine 140, and computing device 120 connected to web server 130 over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication between computing device 120 and web server 130.

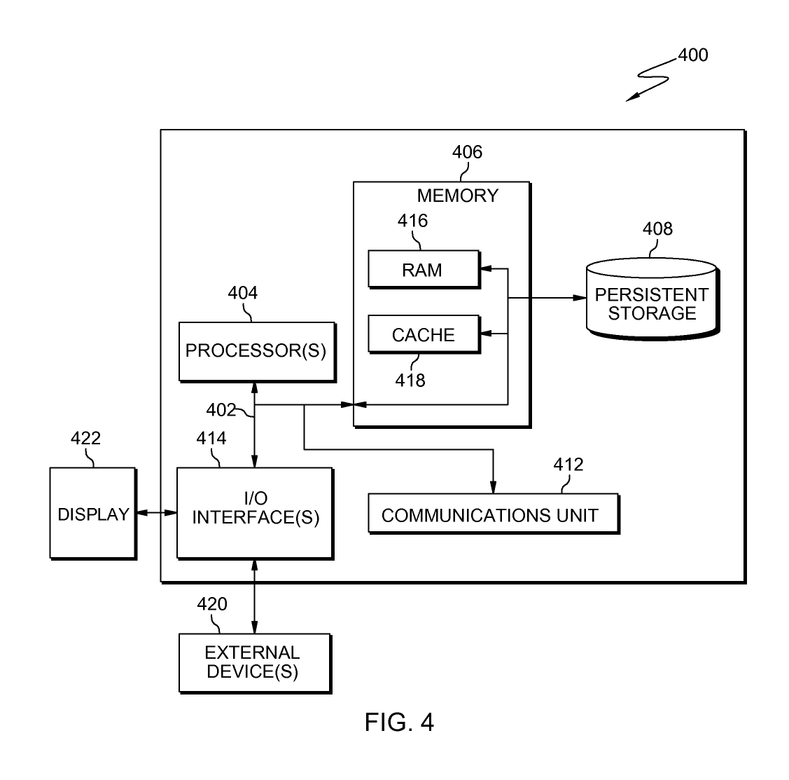

Computing device 120 may be a computing device, such as a laptop computer, a tablet computer, a netbook computer, a personal computer (PC), a desktop computer, a personal digital assistant (PDA), a smart phone or wearable device, a thin client, or any programmable electronic device capable of communicating with web server 130 via network 110. In other embodiments, computing device 120 may be a management server, a web server, or any other electronic device or computing system capable of receiving and sending data. Computing device 120 may include internal and external hardware components, as depicted and described in further detail with respect to FIG. 4.

Web server 130 includes transactional capability enabling program 132. Web server 130 may be a management server, a web server, or any other electronic device or computing system capable of receiving and sending data. In other embodiments of the present invention, web server 130 can represent a computing system utilizing clustered computers and components to act as a single pool of seamless resources when accessed through a network. In this exemplary embodiment, web server 130 is capable of receiving requests for data from computing device 120, via network 110. Web server 130 may include internal and external hardware components, as depicted and described in further detail with respect to FIG. 4.

Transactional capability enabling program 132 receives requests for digital content. Transactional capability enabling program 132 can receive requests for digital content and can enable transactional capabilities for digital content. Transactional capability enabling program 132 can generally include any software capable of enabling digital content and communicating with intelligent management engine 140.

Database 150 is a central storage for a set of user, object, and vendor data. Database 150 can be implemented using any non-volatile storage medium known in the art. For example, authentication database can be implemented with a tape library, optical library, one or more independent hard disk drives, or multiple hard disk drives in a redundant array of independent disks (RAID). In this exemplary embodiment, database 150 contains the customized set of objects and vendors for each related user. For example, database 150 may contain products of interest to the user and the vendors that sell those products.

Intelligent management engine 140 is a processor that accesses, processes, and presents the data stored by database 150 and/or other data sources. Intelligent management engine 140 has the ability to generate a list of all the objects being referred to in digital content. Intelligent management engine 140 can also generate a list of all vendors who are ready to vend a given object from the object list. Intelligent management engine 140 can then generate an exhaustive object-vendor mapping list and allocate weightage to each object-vendor pair. Weightages can be decided based on user specific information or even other external sources. In this exemplary embodiment, intelligent management engine 140 uses additional information which is available about a given user. For example, if the user who is browsing the digital content is a forty year-old woman who indicated that she likes the store Target on her FACEBOOK® page, or a twenty-five year-old male who lives in New York City and likes VERSACE®, intelligent management engine 140 can link user-specific content to different vendors.

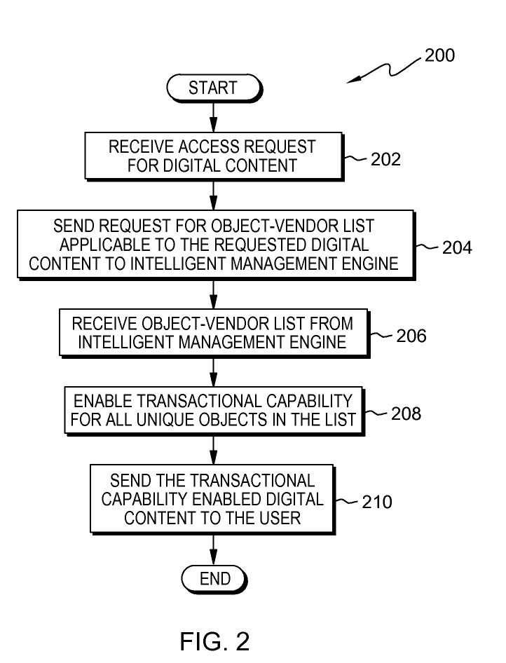

FIG. 2 is a flowchart, 200, depicting operational steps for enabling transactional capability, in accordance with an embodiment of the present invention.

In step 202, transactional capability enabling program 132 receives an access request. In this exemplary embodiment, transactional capability enabling program 132 receives a request from computing device 120, via network 110, for digital content. For example, this access request may be initiated by entering a URL into a web browsing software installed on the user's digital device. Along with the access request, the web browsing software may also send user specific information to web server 130, which is responsible for fulfilling a user's URL access request.

In step 204, transactional capability enabling program 132 sends a request for the object-vendor list applicable to the requested digital content to intelligent management engine 140. In this exemplary embodiment, transactional capability enabling program 132 forwards the digital content requested and the user specific information to intelligent management engine 140. Intelligent management engine 140 generates a list of all objects referenced in the digital content and a list of vendors associated with respective objects from the list of all objects to create an object-vendor mapping list. A weight is assigned to each object-vendor pair according to the user specific information or predetermined external sources. For example, a greater assigned weight may indicate an object-vendor pair which has greater relevance to the user specific information, while a lower assigned weight may indicate an object-vendor pair which has a lower relevance to the user specific information.

In step 206, transactional capability enabling program 132 receives the object-vendor mapping list from intelligent management engine 140.

In step 208, transactional capability enabling program 132 enables transactional capability for all unique objects in the object-vendor mapping list received in step 206. In this exemplary embodiment, where there are more than one vendors associated with a given object, transactional capability enabling program 132 determines a display order of vendors associated with the given object using the weights assigned in step 204.

In step 210, transactional capability enabling program 132 sends the transactional capability enabled digital content to the requesting user. In this exemplary embodiment, transactional capability enabling program 132 delivers the transactional capability in a way that it would be highlighted and displayed only when the user requests it. For example, the user may move his mouse cursor over an object of interest and right click to obtain the object-vendor list. In the same example, when the user right clicks on an object he is not interested in, the normal menu of related commands opens. When the user requests more choices for objects and/or vendors, transactional capability enabling program 132 forwards a request to intelligent management engine 140 to fetch objects from the object-vendor mapping list with a lower weight threshold. When the user requests all available options for objects and/or vendors, transactional capability enabling program 132 forwards a request to intelligent management engine 140 to fetch all available object-vendor sets.

Accordingly, by performing the operational steps of FIG. 2, transactional ability is efficiently enabled for objects referred to in digital content, where the objects are intelligently customized based on user related data.

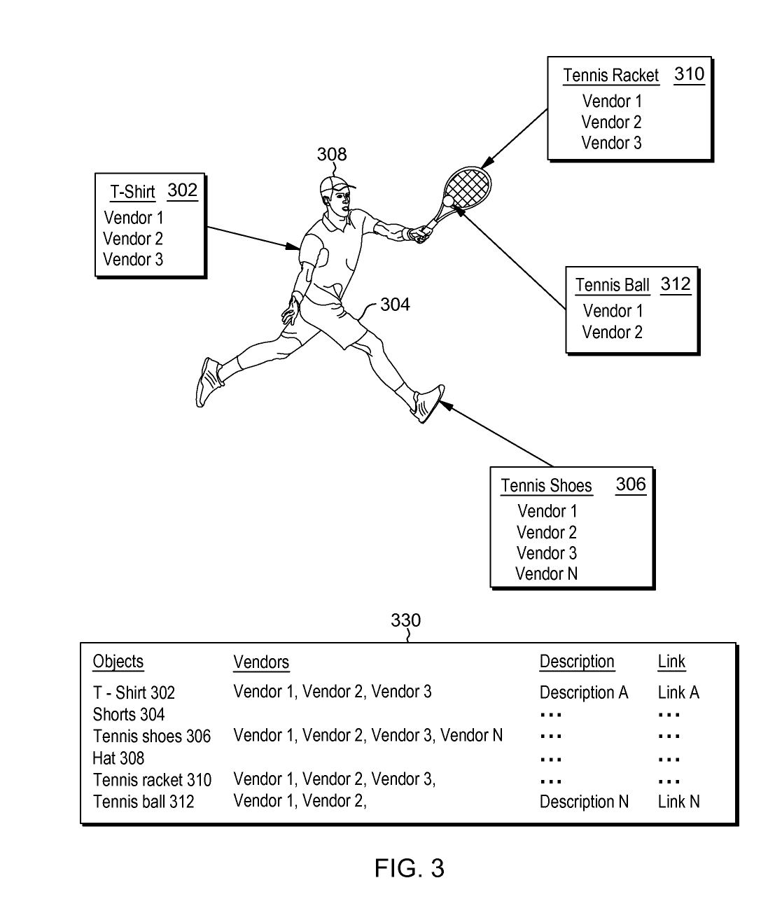

FIG. 3 is a diagram depicting an example of transactional capability enabled digital content displayed on a computing device, in accordance with an embodiment of the present invention.

In this example, a user is browsing digital content and comes across a picture of a tennis player. The tennis player is wearing t-shirt 302, shorts 304, tennis shoes 306, and hat 308. The tennis player is holding tennis racket 310 and hitting tennis ball 312. The user is interested in tennis, specifically tennis equipment and apparel. The user is not interested, however, in shorts and hats. Transactional capability enabling program 132 sends a request for the object-vendor list applicable to the requested digital content (e.g., the picture of the tennis player) to intelligent management engine 140 (step 204). Transactional capability enabling program 132 also forwards the digital content (e.g., the picture of the tennis player) requested and any user specific information to intelligent management engine 140. Intelligent management engine 140 generates list 330 of all objects referred to in the digital content (i.e., hat, t-shirt, shorts, tennis shoes, tennis racket, and tennis ball). List 330 also comprises all vendors who are ready to vend a given object, a description of each object, and a link to initiate an online transaction for each object-vendor pair. For example, for tennis racket 310, intelligent management engine 140 may provide HEAD®, WILSON®, and Babolat as Vendor 1, Vendor, 2, and Vendor 3, respectively. Transactional capability enabling program 132 receives the object-vendor list from intelligent management engine 140 (step 206) and enables transactional capability for all unique objects in the list (step 208). The digital content is then sent back to the user such that the user can display the objects and their corresponding vendors (step 210). Because the user is not interested in hats or shorts, the transactional capability for hat 308 and shorts 304 were not enabled in step 208.

FIG. 4 is a block diagram of internal and external components of computing device 400, which is representative of the computing devices of FIG. 1, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 400 includes communications fabric 402, which provides for communications between one or more processing units 404, memory 406, persistent storage 408, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 416 and cache memory 418. In general, memory 406 can include any suitable volatile or non-volatile computer readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410 provides for communications with other computer systems or devices via a network. In this exemplary embodiment, communications unit 410 includes network adapters or interfaces such as a TCP/IP adapter cards, wireless Wi-Fi interface cards, or 3G or 4G wireless interface cards or other wired or wireless communications links. The network can comprise, for example, copper wires, optical fibers, wireless transmission, routers, firewalls, switches, gateway computers and/or edge servers. Software and data used to practice embodiments of the present invention can be downloaded to computing device 400 through communications unit 410 (i.e., via the Internet, a local area network, or other wide area network). From communications unit 410, the software and data can be loaded onto persistent storage 408.

One or more I/O interfaces 412 allow for input and output of data with other devices that may be connected to computing device 400. For example, I/O interface 412 can provide a connection to one or more external devices 420 such as a keyboard, computer mouse, touch screen, virtual keyboard, touch pad, pointing device, or other human interface devices. External devices 420 can also include portable computer readable storage media such as, for example, thumb drives, portable optical or magnetic disks, and memory cards. I/O interface 412 also connects to display 422.

Display 422 provides a mechanism to display data to a user and can be, for example, a computer monitor. Display 422 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for enabling transactional ability for objects comprising:
receiving, by one or more computer processors, a request for digital content;
sending, by one or more computer processors, a request for an object-vendor list applicable to said digital content to a management engine;
receiving, by one or more computer processors, an object-vendor list from said management engine;
enabling, by one or more computer processors, transactional capability for all unique objects in said object-vendor list, wherein a display order of said object-vendor list is based on an assigned weight; and
sending, by one or more computer processors, said digital content to a user, wherein said digital content comprises enabled transactional capability.

2. The method of claim 1, wherein receiving the request for digital content comprises:
receiving, by one or more computer processors, information associated with a user.

3. The method of claim 1, wherein sending said request for an object-vendor list applicable to said digital content to a management engine comprises:
generating, by said management engine, a list of all objects referenced in said digital content;
generating, by said management engine, a list of vendors associated with said list of all objects referenced in said digital content;
creating, by said management engine, said object-vendor list, wherein said object-vendor list comprises the list of all objects matched to the list of vendors; and
assigning, by said management engine, a weight to an object-vendor pair on said object-vendor list, wherein the object-vendor pair comprises an object of the list of all objects matched to a vendor from the list of vendors.

4. The method of claim 3, further comprising:
determining, by one or more computer processors, whether the assigned weight is greater than a predetermined threshold weight; and
in response to determining the assigned weight is greater than the predetermined threshold weight, displaying, by one or more computer processors, the object-vendor pair associated with the assigned weight.

5. The method of claim 4, further comprising:
receiving, by one or more computer processors, a request for an additional list of all objects matched to the list of vendors;
sending, by one or more computer processors, said request for the additional list of all objects matched to the list of vendors, to said management engine;
receiving, by one or more computer processors, an object-vendor list with the list of all objects matched to the list of vendors having an assigned weight below the predetermined threshold weight; and
displaying, by one or more computer processors, said list of all objects matched to the list of vendors having the assigned weight below the predetermined threshold weight, to said user.

6. The method of claim 1, wherein the assigned weight is based on a set of user preferences and social media input of the user.

7. The method of claim 1, wherein sending said digital content to said user comprises:
delivering, by one or more computer processors, said enabled transactional capability, to a user interface, in a selectable format; and
displaying, by one or more computer processors, said enabled transactional capability in response to a user gesture indicating a user request.

8. A computer program product comprising:
a computer readable storage medium and program instructions stored on the computer readable storage medium, the program instructions comprising:
program instructions to receive a request for digital content;
program instructions to send a request for an object-vendor list applicable to said digital content to a management engine;
program instructions to receive an object-vendor list from said management engine;
program instructions to enable transactional capability for all unique objects in said object-vendor list, wherein a display order of said object-vendor list is based on an assigned weight; and
program instructions to send said digital content to a user, wherein said digital content comprises enabled transactional capability.

9. The computer program product of claim 8, wherein the program instructions to receive a request for digital content comprise:
program instructions to receive information associated with a user.

10. The computer program product of claim 8, wherein the program instructions to send said request for an object-vendor list applicable to said digital content to a management engine comprise:
program instructions to generate a list of all objects referenced in said digital content;
program instructions to generate a list of vendors associated with said list of all objects referenced in said digital content;
program instructions to create said object-vendor list, wherein said object-vendor list comprises the list of all objects matched to the list of vendors; and
program instructions to assign a weight to an object-vendor pair on said object-vendor list, wherein the object-vendor pair comprises an object of the list of all objects matched to a vendor from the list of vendors.

11. The computer program product of claim 10, further comprising:
program instructions to determine whether the assigned weight is greater than a predetermined threshold weight; and
program instructions to, in response to determining the assigned weight is greater than the predetermined threshold weight, display the object-vendor pair associated with the assigned weight.

12. The computer program product of claim 11, further comprising:
program instructions to receive a request for an additional list of all objects matched to the list of vendors;
program instructions to send said request for the additional list of all objects matched to the list of vendors to said management engine;
program instructions to receive an object-vendor list with the list of all objects matched to the list of vendors having an assigned weight below the predetermined threshold weight; and
program instructions to display said list of all objects matched to the list of vendors having the assigned weight below the predetermined threshold weight to said user.

13. The computer program product of claim 8, wherein the assigned weight is based on a set of user preferences and social media input of the user.

14. The computer program product of claim 8, wherein the program instructions to send said digital content to said user comprise:
program instructions to deliver said enabled transactional capability, to a user interface, in a selectable format; and
program instructions to display said enabled transactional capability in response to a user gesture indicating a user request.

15. A computer system comprising:
one or more computer processors;
one or more computer readable storage media;
program instructions stored on the computer readable storage media for execution by at least one of the one or more computer processors, the program instructions comprising:
program instructions to receive a request for digital content;
program instructions to send a request for an object-vendor list applicable to said digital content to a management engine;
program instructions to receive an object-vendor list from said management engine;
program instructions to enable transactional capability for all unique objects in said object-vendor list, wherein a display order of said object-vendor list is based on an assigned weight; and
program instructions to send said digital content to a user, wherein said digital content comprises enabled transactional capability.

16. The computer system of claim 15, wherein the program instructions to send said request for an object-vendor list applicable to said digital content to a management engine comprise:
program instructions to generate a list of all objects referenced in said digital content;
program instructions to generate a list of vendors associated with said list of all objects referenced in said digital content;
program instructions to create said object-vendor list, wherein said object-vendor list comprises the list of all objects matched to the list of vendors; and
program instructions to assign a weight to an object-vendor pair on said object-vendor list, wherein the object-vendor pair comprises an object of the list of all objects matched to a vendor from the list of vendors.

17. The computer system of claim 16, further comprising:
program instructions to determine whether the assigned weight is greater than a predetermined threshold weight; and
program instructions to, in response to determining the assigned weight is greater than the predetermined threshold weight, display the object-vendor pair associated with the assigned weight.

18. The computer system of claim 17, further comprising:
program instructions to receive a request for an additional list of all objects matched to the list of vendors;
program instructions to send said request for the additional list of all objects matched to the list of vendors to said management engine;
program instructions to receive an object-vendor list with the list of all objects matched to the list of vendors having an assigned weight below the predetermined threshold weight; and
program instructions to display said list of all objects matched to the list of vendors having the assigned weight below the predetermined threshold weight to said user.

19. The computer system of claim 15, wherein the assigned weight is based on a set of user preferences and social media input of the user.

20. The computer system of claim 15, wherein the program instructions to send said digital content to said user comprise:
program instructions to deliver said enabled transactional capability, to a user interface, in a selectable format; and
program instructions to display said enabled transactional capability in response to a user gesture indicating a user request.
